(19) United States
(12) Patent Application Publication
(10) Pub. No.: US 2015/0287496 A1
(43) Pub. Date: Oct. 8, 2015

(54) ALUMINUM ELECTRIC WIRE WITH CRIMP-TYPE TERMINAL AND METHOD OF MANUFACTURING THE SAME

(71) Applicant: YAZAKI CORPORATION, Tokyo (JP)

(72) Inventor: Kei SATO, Shizuoka (JP)

(73) Assignee: YAZAKI CORPORATION, Tokyo (JP)

(21) Appl. No.: 14/741,743

(22) Filed: Jun. 17, 2015

Related U.S. Application Data
(63) Continuation of application No. PCT/JP2013/084571, filed on Dec. 25, 2013.

(30) Foreign Application Priority Data
Dec. 26, 2012 (JP) 2012-281973

(51) Int. Cl. H01B 7/282; H01B 5/12; H01R 43/05; H01R 4/18; H01R 43/00; H01B 1/02; H01B 7/00

(52) U.S. Cl. CPC H01B 7/282; H01B 1/02; H01B 5/12; H01B 7/00; H01R 4/18; H01R 43/005; H01R 43/05

(57) ABSTRACT

An aluminum electric wire with crimp-type terminal includes a coated electric wire including a conductor having a plurality of twisted aluminum element wires made of an aluminum alloy, a conductor portion where the plurality of aluminum element wires exposed by stripping an insulating coating of the coated electric wire are integrally formed into a solid wire, a crimp-type terminal made of a copper alloy having a conductor crimping portion crimped to couple to the conductor portion formed into the solid wire, and a water-repellent agent provided for a front side exposed conductor portion and a rear side exposed conductor portion 49 exposed to outside air without being covered by the conductor crimping portion of the crimp-type terminal.

### CROSS-REFERENCE TO RELATED APPLICATION

This application is a continuation application of International Application PCT/JP2013/084571, filed on Dec. 25, 2013, and designating the U.S., the entire contents of which are incorporated herein by reference.

### BACKGROUND OF THE INVENTION

1. Field of the Invention

The present invention relates to an aluminum electric wire with crimp-type terminal and a method of manufacturing the same.

2. Description of the Related Art

Recently, in a field of a wire harness wired in a vehicle such as an automobile, an aluminum electric wire aimed at weight reduction or similar effect is noted instead of a copper electric wire. The aluminum electric wire is constituted from a conductor formed from stranded wires with a plurality of twisted aluminum element wires, and covered by an insulating coating. For manufacturing a wire harness with the aluminum electric wire, a crimp-type terminal is coupled to its end. However, when the conductor of an electric wire and the crimp-type terminal are dissimilar metals, contact of moisture to a contact portion of both metals causes galvanic corrosion to progress because the metal being an anode portion dissolves into water as ions.

As an effective prevention technique for such galvanic corrosion, for example, Japanese Patent Application Laid-open No. 2011-233328 discloses a coupled structure.

As illustrated in FIG. 5, a coupled structure 501 includes a coated electric wire 509 and a wire coupling portion 511 for coupling of a wire-distal-end portion 507. The coated electric wire 509 is constituted from a conductor 503 being a metal with a large ionization tendency (base metal: aluminum) covered by an insulating coating 505 and has the wire-distal-end portion 507 exposed by stripping the insulating coating 505 in a distal end side. The coupled structure 501 is constituted from a coupling terminal 513 formed by a metal with the smaller ionization tendency (noble metal: a copper alloy) than the metal forming the conductor 503, and an insulator 515 sealing the wire-distal-end portion 507 coupled to the wire coupling portion 511. Then, in a distal-end-side portion from the wire coupling portion 511 in the coupling terminal 513, a box portion 517 having an internal space communicating in a longitudinal direction is formed, and a wire-coupling-portion-side opening 521 opening at the wire coupling portion 511 of the box portion 517 is blocked with the insulator 515.

With this constitution that the insulator 515 seals the wire coupling portion 511 and blocks the wire-coupling-portion-side opening 521, the above-described coupled structure 501 prevents a electrolytic solution from flowing into the inside of the box portion 517 through the wire-coupling-portion-side opening 521 by the insulator 515, and surely prevents occurrence of electrolytic corrosion caused by attachment of the electrolytic solution to the wire coupling portion 511.

However, though an above-described conventional coupled structure 501 is constituted by covering a wire coupling portion 511 by use of an insulator 515, and preventing the moisture from penetrating into the wire coupling portion 511, a thickness control for the insulator 515 is required for prevention of moisture penetration and causes an increase of manufacturing cost. Additionally, a complicated application control of the insulator 515 along a shape of a crimping portion of the wire coupling portion 511 is also required. For example, the complicated application control of the insulator 515 is required as follows: By repetition of a step that an insulating resin dripped on a surface of the wire coupling portion 511 is controlled so as not to spread over an intended range and is hardened by an ultraviolet irradiation, the insulating resin is coated repeatedly to the wire coupling portion 511.

### SUMMARY OF THE INVENTION

The present invention has been made in view of the above-described circumstances, and it is an object of the present invention to provide an aluminum electric wire with crimp-type terminal and a method of manufacturing the same, which can retard a progression rate of galvanic corrosion at a contact portion between a crimp-type terminal and a conductor with easy operation.

In order to solve the above mentioned problem and achieve the object, an aluminum electric wire with crimp-type terminal according to the present invention includes: a coated electric wire including a conductor having a plurality of twisted element wires made of aluminum or an aluminum alloy; a conductor portion having the plurality of element wires integrally formed into a solid wire, the plurality of element wires being exposed by stripping an insulator of the coated electric wire; a crimp-type terminal made of copper or a copper alloy having a conductor crimping portion crimped to couple to the conductor portion formed into the solid wire; and a water-repellent agent provided for the conductor portion exposed to outside air without being covered by the conductor crimping portion of the crimp-type terminal.

According to the above-described aluminum electric wire with crimp-type terminal, because a conductor portion is integrally formed into a solid wire by a plurality of element wires made of a base metal (made of aluminum or made of an aluminum alloy) and then crimped to couple to a conductor crimping portion of the crimp-type terminal made of a noble metal (made of copper or a copper alloy), it becomes possible to retard acceleration of the galvanic corrosion with an area ratio of a cathode portion/anode portion being decreased. Further, because a water-repellent agent is applied to the conductor portion exposed to outside air without being covered by the conductor crimping portion, it becomes possible to prevent attachment of moisture to the contact portion between the conductor and the crimp-type terminal at the conductor crimping portion, or to retard the acceleration of the galvanic corrosion with a contact area of water minimized.

Further, a method of manufacturing the aluminum electric wire with crimp-type terminal according to the present invention includes: a stripping step of stripping an insulator of a coated electric wire including a conductor having a plurality of twisted element wires made of aluminum or an aluminum alloy so as to expose the conductor; a solid-wire forming step of forming the plurality of element wires integrally into a solid wire in the exposed conductor; a crimping step of crimping to couple a conductor crimping portion of a crimp-type terminal made of copper or a copper alloy to the conductor portion formed into the solid wire; and a water-repellent treatment step of performing a water-repellent process on the conductor portion exposed to outside air without being covered by the conductor crimping portion of the crimp-type terminal.

According to the method of manufacturing the aluminum electric wire with crimp-type terminal, the plurality of element wires made of the base metal (made of aluminum or made of the aluminum alloy) are preliminarily formed into the conductor portion being a solid wire by a solid-wire forming step, and the conductor portion is crimped to couple to the conductor crimping portion of the crimp-type terminal made of the noble metal (made of copper or made of the copper alloy). That is, because the plurality of element wires made of the base metal becomes one conductor portion with a large diameter, the area of the anode portion increases. This ensures decrease of the area ratio of the cathode portion/anode portion and retardation of the acceleration of the galvanic corrosion. Further, a water-repellent treatment step provides the conductor portion, which is exposed to the outside air without being covered by the conductor crimping portion, with water-repellent treatment. As a result, the exposed conductor portion, which is to be the anode portion at the conductor crimping portion of the crimp-type terminal, hardly contacts with water due to a water-repellent effect.

In the method of manufacturing the aluminum electric wire with crimp-type terminal, it is preferable that the solid wire formation is performed by integrating the plurality of element wires by ultrasonic wave welding, heat welding, press working, or soldering.

According to the method of manufacturing the aluminum electric wire with crimp-type terminal, the plurality of element wires can be easily formed into the solid wire without degradation of conductivity.

In the method of manufacturing the aluminum electric wire with crimp-type terminal, it is preferable that the water-repellent treatment is performed by spraying, dripping, or coating of a water-repellent agent on the conductor portion exposed to the outside air.

According to the method of manufacturing the aluminum electric wire with crimp-type terminal, a strict film thickness control is not required, and the water-repellent treatment can be easily performed to the conductor portion at a low cost with a simple facility.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating an aluminum electric wire with crimp-type terminal according to one embodiment of the present invention;

FIG. 2A is a process diagram illustrating an application condition of cream solder in a method of manufacturing the aluminum electric wire with crimp-type terminal;

FIG. 2B is a process diagram illustrating a conductor portion formed in a solid wire;

FIG. 2C is a process diagram illustrating the crimp-type terminal immediately before the conductor portion is crimped;

FIG. 2D is a process diagram illustrating a condition of a water repellent agent being provided on the exposed conductor portion at a conductor crimping portion;

FIG. 3A is a side view of the aluminum electric wire with crimp-type terminal, a part of which is cut out, with the conductor portion crimped to the conductor crimping portion of the crimp-type terminal;

FIG. 3B is a side view of the aluminum electric wire with crimp-type terminal, a part of the which is cut out, with the water repellent agent having been provided on the exposed conductor portion at the conductor crimping portion;

FIG. 4A is a perspective view illustrating an aluminum electric wire for description of a state where the conductor, in which a plurality of element wires are twisted, is exposed in an end;

FIG. 4B is a perspective view illustrating the aluminum electric wire for the description of a state where the conductor has become the conductor portion by being formed into the solid wire; and

FIG. 5 is a perspective view illustrating a crimp-type terminal, a part of which is cut out for the description of a constitution of a crimp-type terminal portion of a conventional electric wire with crimp-type terminal.

### DETAILED DESCRIPTION OF THE PREFERRED EMBODIMENTS

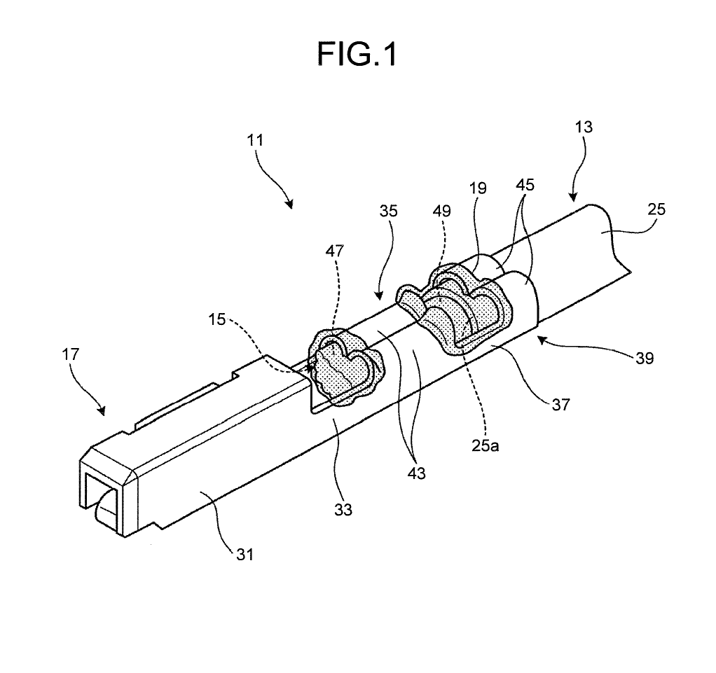

The following describes an embodiment according to the present invention with reference to drawings. As illustrated in FIG. 1, an aluminum electric wire with crimp-type terminal 11 according to one embodiment of the present invention is mainly constituted from a coated electric wire 13, a conductor portion 15 where a plurality of aluminum element wires (element wire) 21 of the coated electric wire 13 is integrally formed into a solid wire, a crimp-type terminal 17, and a water-repellent agent 19.

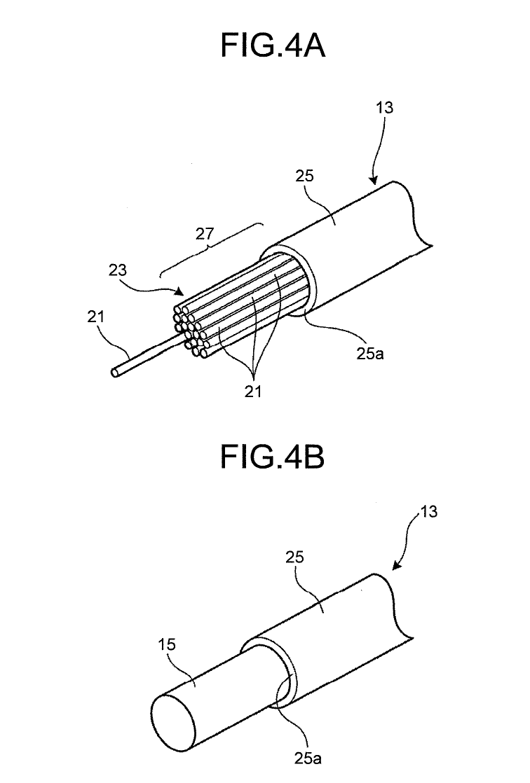

The coated electric wire 13 has a conductor 23 where the aluminum element wires 21 being the plurality of element wires made of aluminum or the aluminum alloy are twisted, and the conductor 23 is covered by an insulating coating 25 being an insulator made of an insulating resin (see FIG. 4A). A distal end side of the coated electric wire 13, which is an end where the crimp-type terminal 17 is coupled, becomes an electric wire distal end portion 27 where the conductor 23 is exposed by stripping the insulating coating 25. As for the aluminum alloy constituting the aluminum element wire 21, for example, an alloy of aluminum and iron is included. This alloy is easily extended and strength (especially tensile strength) of this alloy can be increased compared with the conductor made of aluminum.

Additionally, in this description, the “conductor 23” denotes an object in a state where the aluminum element wires 21 are twisted before a solid-wire forming process, and the “conductor portion 15” described later denotes an object in a state where the aluminum element wires 21 are integrated after the solid-wire forming process.

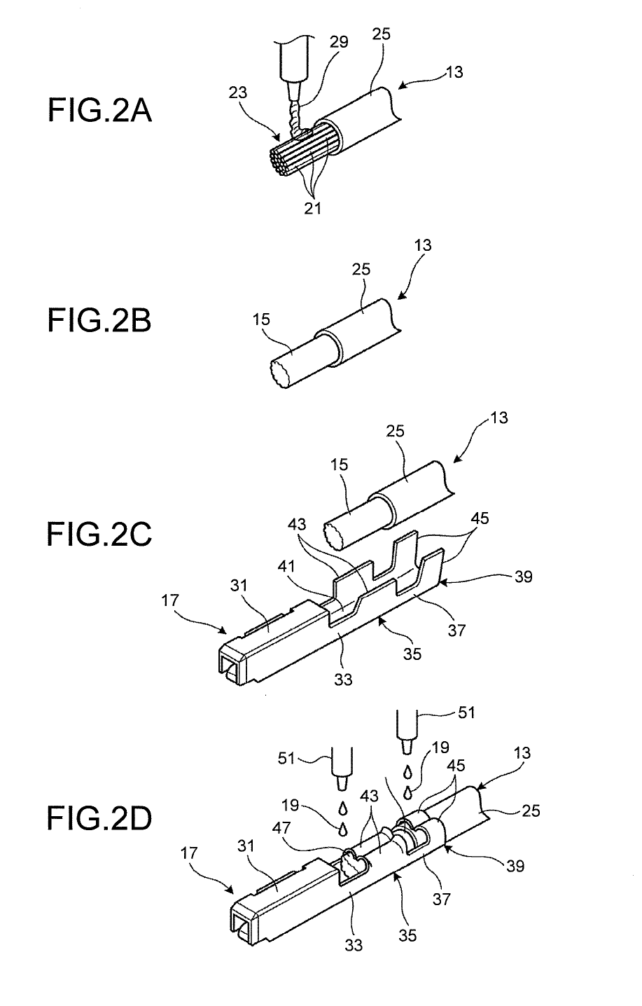

The conductor portion 15 according to the embodiment is formed by the plurality of aluminum element wires 21, which is exposed by stripping the insulating coating 25 of the coated electric wire 13, integrally formed into the solid wire. The solid wire formation can be performed by ultrasonic wave welding, heat welding, press working, soldering, or similar method. In the solid wire formation by ultrasonic wave welding, heat welding, and press working, the solid wire is integrally formed by melting of at least some of the aluminum element wires 21 or diffusion junction due to diffusion of atoms at a metal junction boundary surface. Meanwhile, in the soldering by cream solder 29 or similar solder illustrated in FIG. 2A, the aluminum element wires 21 do not melt. After molten solder is filled in the aluminum element wires 21, the molten solder solidifies to integrally form the solid wire with the solder and the aluminum element wires 21. In any case, the conductor portion 15 formed in the solid wire has a smooth surface enough to prevent water from penetrating into an end surface and an outer peripheral surface.

The crimp-type terminal 17 according to the embodiment is a female-shaped terminal. The crimp-type terminal 17 is integrally and continuously constituted from a box-shaped portion 31 where a male tab of a male-shaped terminal (not illustrated) is inserted from front toward rear in a longitudinal direction, a conductor crimping portion 35 coupled via a front side coupling portion 33 with a predetermined length in the rear from the box-shaped portion 31, and a wire fixing portion 39 coupled via a rear side coupling portion 37 with a predetermined length in the rear from the conductor crimping portion 35. The crimp-type terminal 17 is three-dimensionally constituted by a metallic substrate made of the copper alloy being pressed and folded.

The conductor crimping portion 35 before crimping is constituted from a terminal bottom portion 41 and a conductor crimping piece 43 extending obliquely to an outer upper side from both sides in a width direction of the terminal bottom portion 41, as illustrated in FIG. 2C. Additionally, the wire fixing portion 39 before crimping is also constituted from the terminal bottom portion 41 and an outer cover crimping piece 45 extending obliquely to the outer upper side from both sides in the width direction of the terminal bottom portion 41.

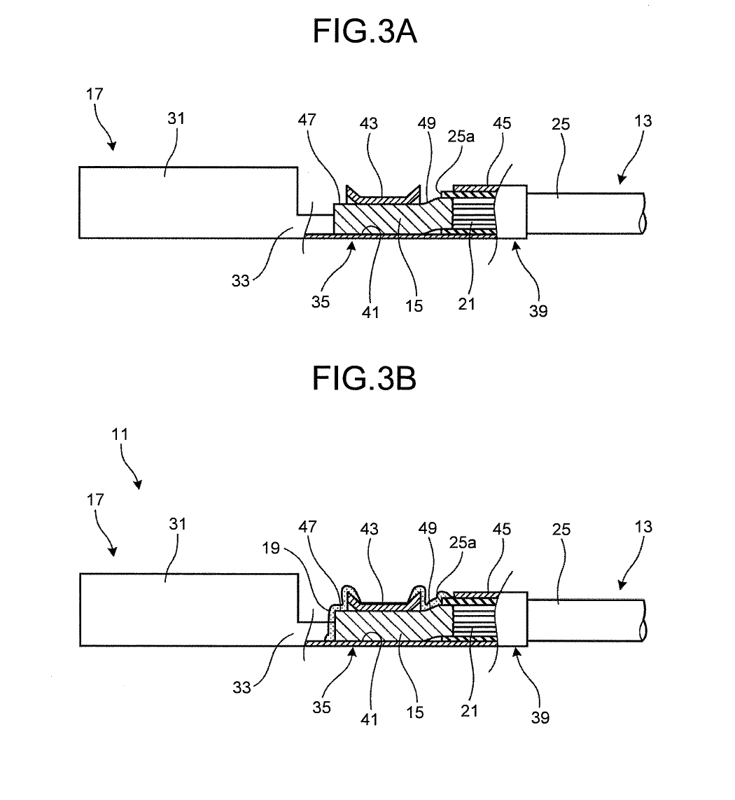

In the aluminum electric wire with crimp-type terminal 11 of the embodiment, a front side exposed conductor portion 47 of the conductor portion 15 exposed to outside air without being covered by the conductor crimping portion 35 is arranged in the front side coupling portion 33, as illustrated in FIG. 2D and FIG. 3A. Additionally, a rear side exposed conductor portion 49 of the conductor portion 15 exposed to the outside air without being covered by the conductor crimping portion 35 is arranged in the rear side coupling portion 37. In the rear side exposed conductor portion 49, a distal end 25a of the insulating coating 25 extends between the conductor crimping piece 43 and the outer cover crimping piece 45, and the rear side exposed conductor portion 49 is exposed between the insulating coating 25 and the conductor crimping piece 43. In the conductor crimping portion 35, the conductor portion 15 is crimped to couple by the conductor crimping piece 43. In crimping for coupling, the conductor crimping piece 43 is crimped so as to hold a periphery of the conductor portion 15 from both sides of the left and the right, and brought into close contact with the periphery of the conductor portion 15, thereby the conductor portion 15 is cut off from the outside air.

In the crimp-type terminal 17, the conductor portion 15 of the coated electric wire 13 is placed in the conductor crimping portion 35, and an insulating coating portion of the coated electric wire 13 is placed in the wire fixing portion 39. Then, by crimping of a pair of conductor crimping pieces 43 and a pair of outer cover crimping pieces 45, the conductor portion 15 is fixed in close contact with the conductor crimping portion 35, and the insulating coating portion is fixed to the wire fixing portion 39.

Then, in the aluminum electric wire with crimp-type terminal 11, as illustrated in FIG. 2D, the conductor portion 15 exposed to the outside air without being covered by the conductor crimping portion 35 of the crimp-type terminal 17 (that is, the front side exposed conductor portion 47 and the rear side exposed conductor portion 49) is provided (attached) with the water-repellent agent 19 by drip from a dripping nozzle 51. Additionally, not limited to the drip from the dripping nozzle 51, the water-repellent agent 19 can be provided by spraying of a jet spray, a coating with a brush, or similar method.

Water repellency of the water-repellent agent 19 denotes keeping off water and characteristics of “repelling water”, not “prevention of penetration of water” as water proof. The water-repellent agent 19 may even be a water-repellent agent having, so-called, super water-repellent. The super water-repellent denotes a phenomenon that a water droplet contacts with respect to a surface with a contact angle more than 150° by high water repellency. As a functional group showing the water repellency, a trifluoromethyl group (—CF₃) is included. When the trifluoromethyl groups, which are orderly aligned in planar shape by a fluorine resin or similar resin, contact with water, the contact angle becomes around 120°. The super water-repellent is the state that the contact angle exceeds 150° by the water-repellency being further strengthened. In the super water-repellent, when water contacts to a coated surface, small water droplets scatter in an instance so as to be repelled, and water droplets remaining on the coated surface keep spherical shapes. This ensures a state that a water film hardly occurs.

Furthermore, as long as the water-repellent agent 19 has good adhesiveness with respect to the conductor portion 15 formed in the solid wire and has durability among commercially available water-repellent agents, a type does not matter. Further, coating thickness of the water-repellent agent 19 coated on the conductor portion 15 is enough as long as the thickness can hold water-repellent effect to the conductor portion 15 over a long period of time.

In the aluminum electric wire with crimp-type terminal 11 of the embodiment, the front side exposed conductor portion 47 and the rear side exposed conductor portion 49 of the conductor portion 15, which are not covered by the conductor crimping portion 35, are exposed to the outside air. Then, at least in the front side exposed conductor portion 47 and the rear side exposed conductor portion 49, because the water-repellent agent 19 is coated on outer surfaces, moisture hardly contacts by occurrence of the water-repellent effect. That is, the water-repellent agent 19 ensures retardation against progress of galvanic corrosion by causing water not to attach to the conductor portion 15 or minimizing the contact of water by the water-repellent effect.

Next, the following describes a method of manufacturing the aluminum electric wire with crimp-type terminal 11 according to the embodiment. The method of manufacturing the aluminum electric wire with crimp-type terminal 11 of the embodiment includes at least a stripping step, a solid-wire forming step, a crimping step, and a water-repellent treatment step.

First, the stripping step causes the conductor 23 to be exposed by stripping the insulating coating 25 of the coated electric wire 13 having the conductor 23 where a plurality of aluminum element wires 21 made of aluminum or the aluminum alloy are twisted. The exposed conductor 23 becomes the electric wire distal end portion 27.

The solid-wire forming step integrally forms the solid wire from the plurality of aluminum element wires 21 in the exposed conductor 23. The solid wire formation is performed by integrating the plurality of aluminum element wires 21 by the ultrasonic wave welding, the heat welding, the press working, the soldering, or similar method. In the embodiment, as illustrated in FIG. 2A and FIG. 2B, the conductor portion 15, which is solidified after application and heating of the cream solder 29 and then formed in the solid wire, is exemplified.

The crimping step crimps and couples the conductor crimping piece 43 formed in the conductor crimping portion 35 of the crimp-type terminal 17 made of copper or the copper alloy to the conductor portion 15 formed in the solid wire, as illustrated in FIG. 2C. Similarly, the crimping step crimps and fixes the outer cover crimping piece 45 formed in the wire fixing portion 39 to the insulating coating 25 of the coated electric wire 13 (see FIG. 3A).

The water-repellent treatment step provides the front side exposed conductor portion 47 and the rear side exposed conductor portion 49 of the conductor portion 15 exposed to the outside air without being covered by the conductor crimping portion 35 of the crimp-type terminal 17 with the water-repellent treatment, as illustrated in FIG. 2D. The water-repellent treatment is performed by dripping of the water-repellent agent 19 by the dripping nozzle 51 with respect to the conductor portion 15 exposed to the outside air. Thus, the front side exposed conductor portion 47 and a front end of the conductor crimping pieces 43 are covered by the water-repellent agent 19, while the rear side exposed conductor portion 49, a rear end of the conductor crimping pieces 43, and a front end of the insulating coating 25 are covered by the water-repellent agent 19. The manufacturing of the aluminum electric wire with crimp-type terminal 11 of the embodiment is completed as described above.

Next, a description will be given of an operation of the aluminum electric wire with crimp-type terminal 11 having the above-described constitution.

In the aluminum electric wire with crimp-type terminal 11 according to the embodiment, the plurality of aluminum element wires 21 made of the base metal (made of aluminum or made of the aluminum alloy) become the conductor portion 15 being integrally formed into the solid wire, and then crimped to couple to the conductor crimping portion 35 of the crimp-type terminal 17 made of noble metal (made of copper or made of the copper alloy). Thus, a reduced area ratio of a cathode portion/anode portion can retard acceleration of the galvanic corrosion. Furthermore, because the conductor portion 15, which is exposed to the outside air without being covered by the conductor crimping portion 35, is provided with the water-repellent agent 19, attachment of moisture to a contact portion between the crimp-type terminal 17 and the conductor 23 at the conductor crimping portion 35 is prevented, or a contact area of water is minimized. Thus, retardation of the acceleration of the galvanic corrosion is ensured.

In a conventional constitution, when water attaches to a contact portion of an element wire and a crimp-type terminal of dissimilar metals, the galvanic corrosion being wet corrosion progresses. Generally, in the wet corrosion, an anode reaction (oxidation reaction) where atoms in a metallic material dissolve into an electrolyte solution as cations and a cathode reaction (reduction reaction) where oxidizing agents receive electrons simultaneously occur in pairs.

In the galvanic corrosion, when the dissimilar metals electrically contact in the electrolyte solution, an electric potential difference occurs due to a difference of an ionization tendency between both metals, and the corrosion progresses. In view of this, the corrosion of a base metal is accelerated compared with the ordinary. In the electrolyte solution, a base metal having a lower electric potential as aluminum has the higher ionization tendency and is easily ionized. Accordingly, when the conductor 23 made of the aluminum alloy and the crimp-type terminal 17 made of the copper alloy having a higher rank of corrosion potential than the conductor 23 contact in the electrolyte solution, elution progresses in the conductor 23 made of the aluminum alloy having the higher ionization tendency. That is, the anode reaction occurs only in the conductor 23.

At this time, though a corrosion rate is determined by an amount of dissolved oxygen reaching to a metal surface, the cathode reaction based on the amount of dissolved oxygen determining the corrosion rate occurs not only on a surface of the conductor made of the aluminum alloy but also on a surface of the crimp-type terminal made of the copper alloy. When the surface areas of the conductor 23 and the crimp-type terminal 17 are identical, the cathode reaction doubles. As a result, a corrosion amount of the conductor 23 made of the aluminum alloy also doubles, and the corrosion is accelerated. That is, the larger the area ratio of the noble metal to the base metal is, the faster the galvanic corrosion progresses. The corrosion rate and the surface area satisfy the following formula (1).

P=P0 (1+B/A) (1)

### However,

P: the corrosion rate of the base metal

P0: the corrosion rate when the base metal exists independently

A: the surface area of the base metal

B: the surface area of the noble metal

Here, “when the base metal exists independently” denotes that the aluminum element wires 21 illustrated in FIG. 4A exists in one single wire. That is, in the surface area of the base metal, the area of a single element wire becomes a target of calculation, not a total surface area, even when a plurality of element wires exist in the conductor 23.

As described above, it is understood that, in the galvanic corrosion, the smaller area ratio of the cathode portion/anode portion can retard the acceleration of the corrosion. In this constitution, the plurality of aluminum element wires 21 with respective small diameters and small surface areas A are formed into the solid wire and become one conductor portion 15 with a large diameter as illustrated in FIG. 4B, and the surface area A of the anode portion increases. This ensures the retardation of a corrosion rate P of the base metal (acceleration of the galvanic corrosion) with the area ratio of the cathode portion/anode portion decreased.

Additionally, in the conductor 23 where the solid wire formation is not performed, when water penetrates by a capillary phenomenon, the aluminum element wires 21 in a center side of the conductor contact with water, and the corrosion is accelerated by an influence of the area ratio of the anode portion. The corrosion of even a single piece of the aluminum element wire 21 in the center side of the conductor causes a rise of electrical resistance at a crimping portion. In contrast to this, according to this constitution, because water do not penetrate due to the conductor portion 15 being formed in the solid wire, the galvanic corrosion does not occur under a disadvantage condition from the above-described area ratio. As a result, the rise of electrical resistance at the crimping portion can be suppressed over a long period of time.

Further, though the conductor portion 15, which is in a exposed state, contacts with the terminal bottom portion 41 of the crimp-type terminal 17 around the conductor crimping portion 35, the front side exposed conductor portion 47 and rear side exposed conductor portion 49, which are the conductor portion 15 exposed to the outside air without being covered by the conductor crimping portion 35, are provided with the water-repellent agent 19. Thus, attachment of moisture to the contact portion between the crimp-type terminal 17 and the conductor portion 15 at the conductor crimping portion 35 is prevented, or the contact area of water is minimized. Accordingly, retardation of the acceleration of the galvanic corrosion is ensured.

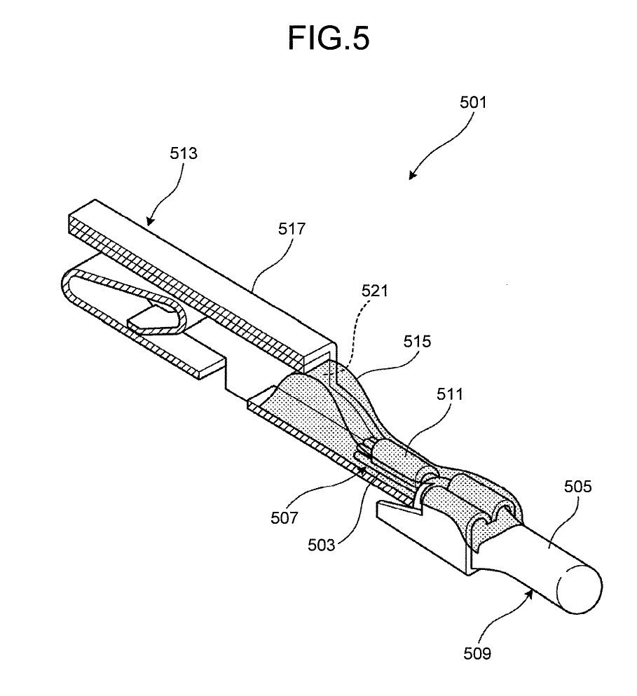

Additionally, as illustrated in FIG. 5, in a conventional constitution where a contact portion between the coupling terminal 513 and the conductor 503 is sealed by the insulator 515 such as a water proof coating, water may penetrate by the capillary phenomenon through a crack generated in the insulator 515 due to a secular change. In this case, an anode portion contacting with water, due to the crack, may rather accelerate the corrosion by the influence of the area ratio. However, in this constitution where the water-repellent agent 19 is provided, the water-repellent effect effectively prevents penetration of water due to the capillary phenomenon, and this also further ensures the retardation of the acceleration of the galvanic corrosion.

Next, a description will be given of the operation of the method of manufacturing the aluminum electric wire with crimp-type terminal 11.

In the method of manufacturing the aluminum electric wire with crimp-type terminal 11 according to the embodiment, the plurality of aluminum element wires 21 made of the base metal (made of aluminum or made of the aluminum alloy) is preliminarily formed into the conductor portion 15 of the solid wire by the solid-wire forming step, and then the conductor portion 15 is crimped to couple to the conductor crimping portion 35 of the crimp-type terminal 17 made of the noble metal (made of copper or made of the copper alloy).

That is, the plurality of aluminum element wires 21 made of the base metal become the one conductor portion 15 with a large diameter, and the area of the anode portion increases. This ensures the smaller area ratio of the cathode portion/anode portion and the retardation of the acceleration of the galvanic corrosion.

Furthermore, due to formation of the conductor portion 15 being the single wire from the plurality of aluminum element wires 21, when the conductor portion 15 is crimped to the conductor crimping portion 35 in high compression by the crimping for coupling, the conductor portion 15 is brought into close contact with the conductor crimping portion 35 more continuously and in the larger area than a case of the plurality of aluminum element wires 21. This more effectively ensures the prevention of penetration of water in the contact portion of the conductor portion 15 and the conductor crimping portion 35 and facilitates avoidance of the occurrence of the galvanic corrosion in the contact portion.

The water-repellent treatment step provides the front side exposed conductor portion 47 and the rear side exposed conductor portion 49 of the conductor portion 15 exposed to the outside air without being covered by the conductor crimping portion 35 with the water-repellent treatment. As a result, the exposed conductor portion 15 being the anode portion in the conductor crimping portion 35 of the crimp-type terminal 17 hardly contacts with water by the water-repellent effect of the water-repellent agent 19. This facilitates shielding the conductor portion 15 from water (aqueous electrolyte solution) and ensures the retardation of the acceleration of the galvanic corrosion.

Further, in the method of manufacturing the aluminum electric wire with crimp-type terminal 11 of the embodiment, soldering of the plurality of aluminum element wires 21 can facilitates the solid wire formation of the plurality of aluminum element wires 21 without degradation of conductivity. Additionally, because the solder forming the conductor portion 15 is also covered with the water-repellent agent 19, the occurrence of the galvanic corrosion in the contact portion between the solder and the crimp-type terminal 17 is also avoided.

Furthermore, in the method of manufacturing the aluminum electric wire with crimp-type terminal 11 of the embodiment, because the water-repellent agent 19 can be attached by spraying, dripping, coating, or similar method regardless of a shape of the conductor crimping portion 35, and a strict film thickness control is not required, the water-repellent treatment can be easily performed at a low cost with simple facility.

Accordingly, according to the aluminum electric wire with crimp-type terminal 11 concerning the embodiment, the progression rate of the galvanic corrosion in the contact portion between the crimp-type terminal 17 and the conductor 23 can be retarded with easy operation. As a result, the electrical resistance at the crimping portion of the conductor crimping portion 35 can be stably maintained over a long period of time.

Furthermore, according to the method of manufacturing the aluminum electric wire with crimp-type terminal 11 concerning the embodiment, the aluminum electric wire with crimp-type terminal 11, in which the progression rate of the galvanic corrosion in the contact portion between the crimp-type terminal 17 and the conductor 23 is retarded, can be produced at a low cost with the easy film thickness control.

Additionally, the present invention is not limited to the above-described embodiment, and deformation, improvement, and similar modification can be made as necessary. Further, material, a shape, a number, an arrangement location, and similar condition of the respective constituent elements in the above-described embodiment are arbitrary and are not limited as long as the present invention can be achieved.

According to the aluminum electric wire with crimp-type terminal concerning the present invention, the retardation of the progression rate of the galvanic corrosion at the contact portion between the crimp-type terminal and the conductor is ensured with easy operation.

According to the method of manufacturing the aluminum electric wire with crimp-type terminal concerning the present invention, the aluminum electric wire with crimp-type terminal with slower progression rate of the galvanic corrosion at the contact portion between the crimp-type terminal and the conductor can be produced with the easy film thickness control at a low cost.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An aluminum electric wire with crimp-type terminal, comprising:
a coated electric wire including a conductor having a plurality of twisted element wires made of aluminum or an aluminum alloy;
a conductor portion having the plurality of element wires integrally formed into a solid wire, the plurality of element wires being exposed by stripping an insulator of the coated electric wire;
a crimp-type terminal made of copper or a copper alloy having a conductor crimping portion crimped to couple to the conductor portion formed into the solid wire; and
a water-repellent agent provided for the conductor portion exposed to outside air without being covered by the conductor crimping portion of the crimp-type terminal.

2. A method of manufacturing an aluminum electric wire with crimp-type terminal according to claim 1, comprising:
a stripping step of stripping an insulator of a coated electric wire including a conductor having a plurality of twisted element wires made of aluminum or an aluminum alloy so as to expose the conductor;
a solid-wire forming step of forming the plurality of element wires integrally into a solid wire in the exposed conductor;
a crimping step of crimping to couple a conductor crimping portion of a crimp-type terminal made of copper or a copper alloy to the conductor portion formed into the solid wire; and
a water-repellent treatment step of performing a water-repellent process on the conductor portion exposed to outside air without being covered by the conductor crimping portion of the crimp-type terminal.

3. The method of manufacturing the aluminum electric wire with crimp-type terminal according to claim 2, wherein
the solid wire formation is performed by integrating the plurality of element wires by ultrasonic wave welding, heat welding, press working, or soldering.

4. The method of manufacturing the aluminum electric wire with crimp-type terminal according to claim 2, wherein
the water-repellent treatment is performed by spraying, dripping, or coating of a water-repellent agent on the conductor portion exposed to the outside air.

5. The method of manufacturing the aluminum electric wire with crimp-type terminal according to claim 3, wherein
the water-repellent treatment is performed by spraying, dripping, or coating of a water-repellent agent on the conductor portion exposed to the outside air.
